(19) United States
(12) Patent Application Publication
(10) Pub. No.: US 2024/0076980 A1
(43) Pub. Date: Mar. 7, 2024

(54) Systems and Methods for Analysis and Simulation of Subsurface Hydraulic Fracture Geometries with Three-Dimensional Rock Discontinuities

(71) Applicants: PetroChina Southwest Oil & Gas Field Company, Chengdu (CN); ZFRAC LLC, Katy, TX (US); BJ Karst Science & Technology Ltd., Beijing (CN)

(72) Inventors: Rui Yong, Chengdu (CN); Jianfa Wu, Chengdu (CN); Joseph Alexander Leines Artieda, Houston, TX (US); Cheng Chang, Chengdu (CN); Jijun Miao, Katy, TX (US); Wei Yu, College Station, TX (US); Hongbing Xie, Beijing (CN)

(73) Assignees: PetroChina Southwest Oil & Gas Field Company, Chengdu (CN); ZFRAC LLC, Katy, TX (US); BJ Karst Science & Technology Ltd., Beijing (CN)

(21) Appl. No.: 17/902,832

(22) Filed: Sep. 4, 2022

(51) Int. Cl. E21B 47/06; E21B 43/26; E21B 47/12

(52) U.S. Cl. CPC E21B 47/06; E21B 43/26; E21B 47/138

(57) ABSTRACT

Systems and methods for simulating subterranean regions having multi-scale, complex fracture geometries in a realistic simulation environment, which includes in the modeling process three-dimensional multi-scale rock discontinuities, hydraulic fractures, and heterogenous reservoir properties. Non-intrusive embedded discrete fracture modeling formulations are applied in conjunction with commercial or in-house simulators to efficiently and accurately model subsurface characteristics including three-dimensional geometries having combinations of complex hydraulic fractures and multi-scale rock discontinuities.

### FIELD OF THE INVENTION

This disclosure relates generally to methods and systems for the simulation of subterranean regions with complex fracture geometries, representing three-dimensional hydraulic fractures and multiscale subterranean rock discontinuities in reservoir simulators using embedded discrete fracture modeling.

### BACKGROUND

Hydrocarbon (oil and gas) extraction is a challenging process, which depends on in-situ rock properties and the geological environment. Some hydrocarbon-bearing reservoirs such as shale formations, with ultra-low permeabilities, present especial challenges due to the inability of hydrocarbons to flow naturally through the host rock. However, recent advancements in horizontal drilling, well completion, and multi-stage hydraulic fracturing have allowed access to hydrocarbons located in ultra-low permeability reservoirs.

Multi-stage hydraulic fracturing is a technique employed to create high-permeability paths along an ultra-low matrix permeability reservoir. During the process, fissures or cracks are formed, which are filled with sand or proppants, resulting in highly-conductive paths where fluids can flow in an easier fashion. The fluids flow from the reservoir and reach the surface through a set of pipe arrangements that connect the subterranean region in the reservoir with the surface.

Reservoir simulation is an excellent technique to model hydraulic fracturing processes. The main objective of the modeling process is to find the best hydraulic fracturing designs that provide maximum economic returns. For that reason, it is key to accurately represent realistic subsurface conditions in reservoir simulation models. A significant challenge in reservoir simulation is the modeling of heterogeneous multiscale discontinuities in the rock.

Natural fractures, bedding layers, and faults are different types of rock discontinuities which present different spatial and geometrical subsurface properties. Rock discontinuities were formed through several processes of deformation caused by tectonic or local stress changes during periods of geological deposition. Such complex processes cause rock discontinuities to have complex three-dimensional shapes and orientations. Some techniques applied in geological workflows can represent such complex shapes and orientations. However, for reservoir simulation modeling, three-dimensional features of rock discontinuities are lost due to the inability of conventional reservoir simulators to model them appropriately.

Conventional dual porosity and dual permeability (DPDK) models upscale rock discontinuities in reservoir simulation models, which severely reduces the resolution of such three-dimensional geometries. Additionally, three-dimensional interactions between networks of rock discontinuities are not represented by the DPDK method, resulting in a loss of key spatial information such as connectivity and intensity. Local grid refinement is a modeling approach which can represent the behavior of fractures by using a progressive refinement in a grid to mimic fracture shapes. However, this technique is simplistic because it was designed to mimic the two-dimensional geometry of hydraulic fractures. Thus, representing three-dimensional rock discontinuities is not compatible with the method. Unstructured gridding is another modeling technique aimed at representing three-dimensional hydraulic fractures and rock discontinuities. This technique generates a grid that conforms to the three-dimensional geometries of rock discontinuities. However, it demands large computational overhead when running field cases with high numbers of rock discontinuities. Additionally, it can cause numerical instability problems due to gridblocks having small sizes, resulting in undesired convergence issues.

Thus, a need remains for improved techniques to efficiently and accurately simulate hydraulic fractures and rock discontinuities in complex subsurface fracture networks.

### SUMMARY

According to an aspect of the invention, a system for simulating a subterranean region having fracture geometries is disclosed. This embodiment includes at least one processor configured with non-transitory instructions, which when executed cause the processor to perform functions including to: a) obtain discrete fracture network digital data representing a 3D model of a subterranean region from a first digital simulator module; b) obtain hydraulic fracture digital data representing a 3D model of the subterranean region from a second digital simulator module; c) convert the digital data from steps (a) and (b) to a digital EDFM format; d) produce a computational domain separate from the first digital simulator module and the second digital simulator module; e) input the converted digital EDFM format data from step (c) into the computational domain to produce output data; f) input the output data of step (e) into a third digital simulator module; and g) generate a simulation of the subterranean region with the third digital simulator module.

According to another aspect of the invention, a method for simulating a subterranean region having fracture geometries is disclosed. In this embodiment, discrete fracture network digital data produced by a first digital simulator module is obtained, the data representing a 3D model of a subterranean region. Hydraulic fracture digital data produced by a second digital simulator module is obtained, the data representing a 3D model of the subterranean region. The discrete fracture network data and hydraulic fracture data are converted to a digital EDFM format. A computational domain separate from the first digital simulator module and the second digital simulator module is produced. The converted digital EDFM format data is input into the computational domain to produce output data. The output data is input into a third digital simulator module. A simulation of the subterranean region is then generated with the third digital simulator.

According to another aspect of the invention, a non-transitory computer-readable medium is disclosed. In this embodiment, the non-transitory computer-readable medium embodies instructions for simulating a subterranean region having fracture geometries which when executed by a computer cause the computer to perform a plurality of functions, including functions to: obtain discrete fracture network digital data produced by a first digital simulator module, the data representing a 3D model of a subterranean region; obtain hydraulic fracture digital data produced by a second digital simulator module, the data representing a 3D model of the subterranean region; convert the obtained discrete fracture network data and hydraulic fracture data to a digital EDFM format; produce a computational domain separate from the first digital simulator module and the second digital simulator module; input the converted digital EDFM format data into the computational domain to produce output data; input the output data into a third digital simulator module; and generate a simulation of the subterranean region with the third digital simulator module.

Other aspects of the embodiments described herein will become apparent from the following description and the accompanying drawings, illustrating the principles of the embodiments by way of example only.

### BRIEF DESCRIPTION OF THE DRAWINGS

The following figures form part of the present specification and are included to further demonstrate certain aspects of the present disclosure and should not be used to limit or define the claimed subject matter. The claimed subject matter may be better understood by reference to one or more of these drawings in combination with the description of embodiments presented herein. Consequently, a more complete understanding of the present embodiments and further features and advantages thereof may be acquired by referring to the following description taken in conjunction with the accompanying drawings, in which like reference numerals may identify like elements, wherein:

FIG. 1 shows a schematic of a subterranean region encompassing a hydraulic fracture and rock discontinuities (natural fractures, bedding layers, and a fault) along a well trajectory.

FIG. 2 shows a schematic of the orientation in three dimensions of a natural fracture represented by its strike and dip angle in a north-east-down coordinate system according to an example of the present disclosure.

FIG. 3 shows a schematic of a fault constructed by using 4 fault segments and united by 2 consecutive vertices according to an example of the present disclosure.

FIG. 4A shows a schematic of three matrix grid blocks (M), a natural fracture (NF), and a bedding layer (BL) in a physical domain according to an example of the present disclosure.

FIG. 4B shows a schematic of the matrix grid blocks, natural fracture, and bedding layer of FIG. 4A in a computational domain according to an example of the present disclosure.

FIG. 5 shows a schematic of two parts of a matrix grid block intersected by a natural fracture according to an example of the present disclosure.

FIG. 6 shows a schematic of the connections between natural fracture segments in a natural fracture embedded in a reservoir grid according to an example of the present disclosure.

FIG. 7 shows a schematic of the intersection between two natural fractures in a grid block where each fracture is divided into two parts after the intersection according to an example of the present disclosure.

FIG. 8 shows a schematic of a non-planar hydraulic fracture modeled as consecutive polygons according to an example of the present disclosure.

FIG. 9 shows a flow chart of a workflow for hydraulic fracture modeling using 3D rock discontinuities according to an example of the present disclosure.

FIG. 10 shows a three-dimensional geological model depicting porosity heterogeneity according to an example of the present disclosure.

FIG. 11 shows a simulation modeling of a well trajectory, natural fracture model, bedding layer model, and a fault system model according to an example of the present disclosure.

FIG. 12 shows a simulation modeling of a hydraulic fracture system from a conventional hydraulic fracture propagation model showing hydraulic fracture width in each fracture according to an example of the present disclosure.

FIG. 13 shows a simulation modeling of a 3D DFN connected network of a hydraulic fracture system according to an example of the present disclosure.

FIG. 14 shows a plot comparison in cumulative gas production between a case with only hydraulic fractures and a case with hydraulic fractures and rock discontinuities according to an example of the present disclosure.

FIG. 15 shows a plot comparison in cumulative water production between a case with only hydraulic fractures and a case with hydraulic fractures and rock discontinuities according to an example of the present disclosure.

FIG. 16 shows a simulation modeling of pressure distribution in a fracture system for a base case with only hydraulic fractures according to an example of the present disclosure.

FIG. 17 shows a simulation modeling of pressure distribution in a fracture system for a case with hydraulic fractures and rock discontinuities according to an example of the present disclosure.

FIG. 18 shows a simulation modeling of drainage reservoir volume in the matrix for a base case with only hydraulic fractures according to an example of the present disclosure.

FIG. 19 shows a simulation modeling of drainage reservoir volume in the matrix for a case with hydraulic fractures and rock discontinuities according to an example of the present disclosure.

FIG. 20 shows a system for simulating a subterranean region according to an example of the present disclosure.

### DETAILED DESCRIPTION

The foregoing description of the figures is provided for the convenience of the reader. It should be understood, however, that the embodiments are not limited to the precise arrangements and configurations shown in the figures. In the development of any actual embodiment, numerous implementation-specific decisions may need to be made to achieve the design-specific goals, which may vary from one implementation to another. It will be appreciated that such a development effort, while possibly complex and time-consuming, would nevertheless be a routine undertaking for persons of ordinary skill in the art having the benefit of this disclosure.

Embodiments of this disclosure present efficient techniques to model and simulate subterranean regions with complex three-dimensional (3D) geometries. Through non-neighboring connections (NNCs), an embedded discrete fracture modeling (EDFM) formulation is applied to data representing a subterranean region to accurately model or simulate formations with complex geometries such as fracture networks and nonplanar fractures. The data representing the subterranean region to be modeled may be obtained by conventional means as known in the art, such as formation evaluation techniques, reservoir surveys, seismic exploration, etc. The subterranean region data may comprise information relating to the fractures, the reservoir, and the wells, including number, location, orientation, length, height, aperture, permeability, reservoir size, reservoir permeability, reservoir depth, well number, well radius, well trajectory, temperature, etc. EDFM modeling techniques are further describe in U.S. Pat. No. 10,914,140. The entire contents of U.S. Pat. No. 10,914,140 are hereby incorporated by reference into this disclosure.

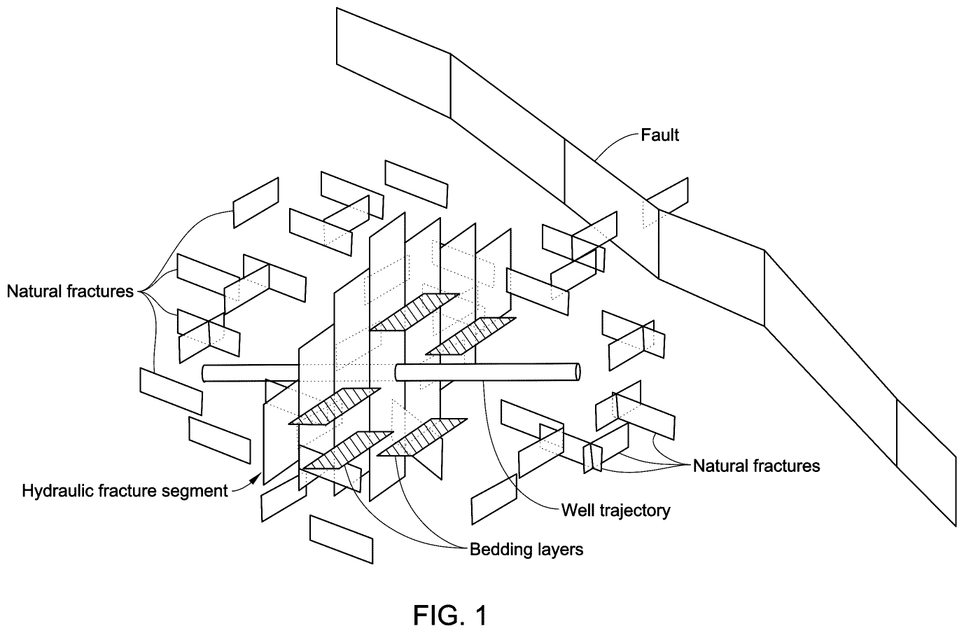

During the hydraulic fracture propagation process in the subsurface, hydraulic fractures produce physical interactions with the pre-existing rock discontinuities, which creates a connected network that encompasses hydraulic fractures and the connected rock discontinuities that are intersected. FIG. 1 shows an example of such a subsurface network. Performing a spatial connectivity analysis to the whole network allows one to differentiate the connected or disconnected status of each rock discontinuity with respect to the main hydraulic fracture system. Different values of conductivity can be assigned to each subgroup of rock discontinuities (lower values for disconnected rock discontinuities and larger ones otherwise) in order to mimic rock discontinuities' effects on reservoir modeling.

### I Three-Dimensional DFN and Hydraulic Fracture Modeling in Finite-Difference Reservoir Simulators Using EDFM

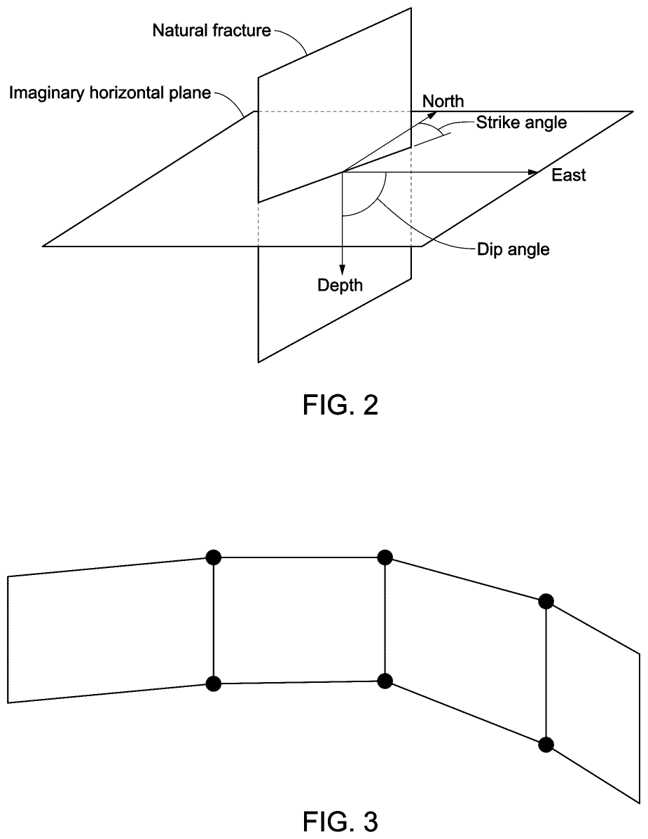

Rock discontinuities present complex shapes and orientations. In some embodiments of this disclosure, natural fractures and bedding layers are modeled using convex or concave planar polygons, having any number of vertices. Natural fractures and bedding layers also possess an orientation with respect to the true north, characterized by its strike or azimuth angle, and with respect to an intersecting imaginary horizontal plane, characterized by its dip angle. FIG. 2 depicts natural fracture orientation in 3D space. Hydraulic fractures or faults, on the other hand, are modeled using consecutive polygons, in which at least two vertices of each consecutive polygon coincide, as depicted in FIG. 3. Each polygon present in a hydraulic fracture or fault is called either “hydraulic fracture or fault segment”, respectively. Non-planar behavior can be modeled by changing the orientation of consecutive polygons and preserving original vertices connections.

EDFM formulations of this disclosure provide two descriptions of a reservoir domain: physical and computational domain. The physical domain accounts for real physical interactions occurring in the subsurface between the reservoir, hydraulic fractures, and rock discontinuities. The computational domain represents three-dimensional interactions between the matrix cells, hydraulic fractures, and rock discontinuities using computational representations thereof. When a rock discontinuity or hydraulic fracture segment intersects a matrix cell, an additional cell is added in the computational domain to represent such interaction, which originally occurs in the physical domain. Newly added cells in the computational domain are different than the original matrix cells and can be called “rock discontinuity cells”, for rock discontinuities; and “hydraulic fracture cells”, for hydraulic fractures. Depending on the size of the rock discontinuity or hydraulic fracture segment, they can interact with either one or several matrix cells, which generates one or several rock discontinuity or hydraulic fracture cells, respectively.

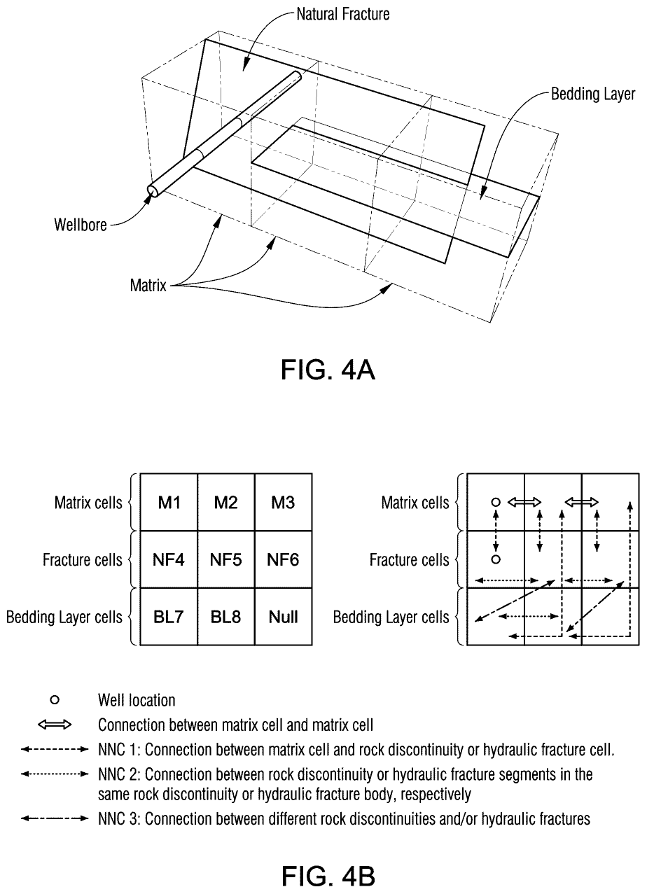

FIG. 4A represents the interaction between a natural fracture, a bedding layer, and three matrix cells in a reservoir in the physical domain. The natural fracture penetrates three matrix cells, resulting in the creation of three natural fracture segments and three new rock discontinuity cells in the computational domain, shown in FIG. 4B. The bedding layer penetrates two matrix cells, which creates two bedding layer segments and adds two additional rock discontinuity cells to the computational domain. Additionally, the second and third natural fracture segment intersects the two bedding layer segments of the bedding layer; thus, those interactions are also numerically represented. Notice the addition in the computational domain of a new type of cell called “null cell”, which represents a cell that does not have any interaction with any cell in the computational domain. Its inclusion in the computational domain is an artifice that allows to preserve the structure of the computational domain, without creating empty regions in the computational domain.

Conventional approaches inside reservoir simulators to handle flow communication between cells include the generation of connections between matrix cells. After including rock discontinuity and/or hydraulic fracture cells in the computational domain, EDFM embodiments of this disclosure remove the connections automatically generated by the reservoir simulator for the rock discontinuity and/or hydraulic fracture gridblocks. Depending on the initial data, EDFM creates NNCs between either (1) the matrix and rock discontinuity cells and/or (2) the matrix and hydraulic fracture cells to represent fluid flow between them, which happens in the physical domain, but are represented virtually in the computational domain. FIG. 4B depicts interactions between matrix and rock discontinuity cells. Three different types of non-neighboring connections occur in the computational domain:
NNC 1: connection between matrix cell and rock discontinuity or hydraulic fracture cell.
NNC 2: connection between rock discontinuity or hydraulic fracture segments in the same rock discontinuity or hydraulic fracture body, respectively.
NNC 3: connection between different rock discontinuities and/or hydraulic fractures.

Fluid flow between two NNCs is represented by the relative mobility of the phase, a transmissibility factor, and the flow potential between the two NNC gridblocks. Additionally, when a well trajectory intersects a rock discontinuity or hydraulic fracture, a well index is calculated to represent such intersection, which overrides the rock discontinuity or hydraulic fracture definition and modifies it to define a well block.

Computations of flow communication between matrix, hydraulic fractures, and rock discontinuities use an EDFM pre-processor that calculates geometrical intersections and fluid flow computations between the elements in three-dimensions. The pre-processor inputs grid information, hydraulic fractures, and/or rock discontinuities; it outputs additional grids' transmissibility factors, number, connectivity, and geometrical parameters to be used for the reservoir simulator embodiments. The pre-processor can be constructed using any programming language.

### II Matrix-Rock Discontinuity or Matrix-Hydraulic Fracture Intersections

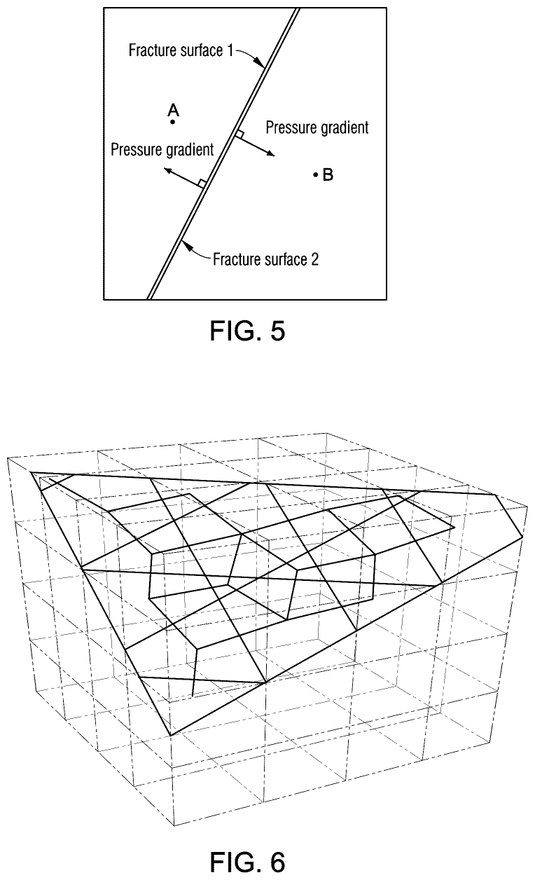

When a rock discontinuity or hydraulic fracture penetrates a matrix grid block, the grid block is divided into two parts, as depicted in FIG. 5. Assuming a linear pressure gradient on each side of the rock discontinuity or hydraulic fracture plane, a transmissibility factor for matrix-rock discontinuity or matrix-hydraulic fracture is calculated as follows:

$${T}_{f - m} = \frac{2 {A}_{f} \vec{n} \cdot ( \dot{K} \cdot \vec{n} )}{{d}_{f - m}} , \qquad ( 1 )$$

where T_{f-m} is the transmissibility factor, A_{f} is the area of rock discontinuity or hydraulic fracture segment on one side, \dot{K} is the matrix permeability tensor, \vec{n} is the unit normal vector of the rock discontinuity or hydraulic fracture plane, and d_{f-m} is the average normal distance between the rock discontinuity or hydraulic fracture plane and the matrix block calculated as follows:

$${d}_{f - m} = \frac{{\int }_{V} {x}_{n} d V}{V} , \qquad ( 2 )$$

where V is the matrix block volume, and xₙ is the distance from a volume element in V to the rock discontinuity or hydraulic fracture plane.

There may be cases where the rock discontinuity or hydraulic fracture does not fully penetrate the matrix grid block. Here, pressure distribution inside the grid block deviates from the assumption of linear distribution, so we assume that the transmissibility factor is proportional to the area of the rock discontinuity or hydraulic fracture segment, and the actual area of the rock discontinuity or hydraulic fracture segment is used.

### III Rock Discontinuity-Rock Discontinuity or Hydraulic Fracture-Hydraulic Fracture Connection

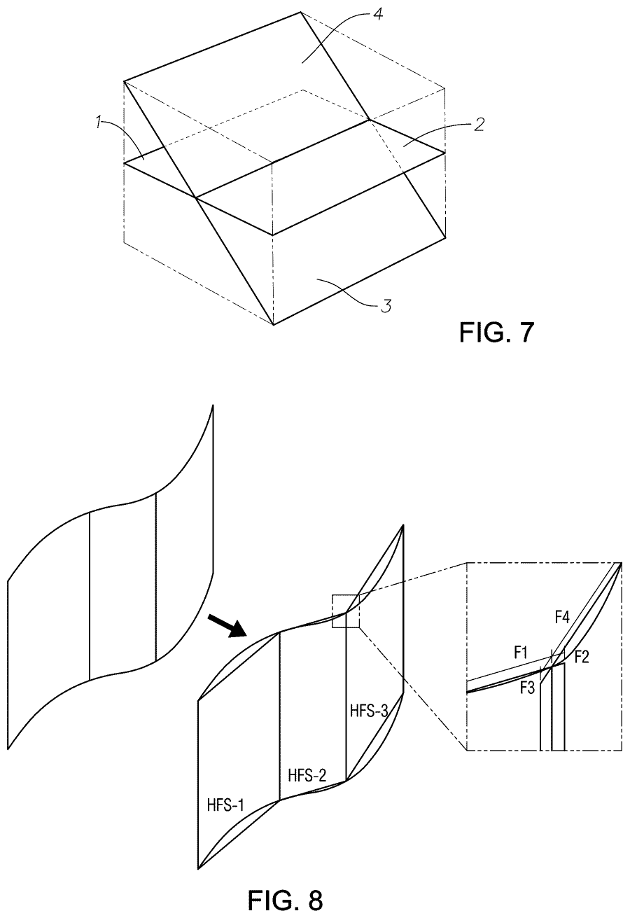

When a rock discontinuity or hydraulic fracture is embedded into a matrix grid block system, the rock discontinuity or hydraulic fracture is discretized into several rock discontinuity or hydraulic fracture segments, which represent the space it occupies in each intersecting grid block, as depicted in FIG. 6. The fluid flow through the rock discontinuity or hydraulic fracture is represented by the connections between rock discontinuity or hydraulic fracture segments. The transmissibility factor between two neighboring rock discontinuity or hydraulic fracture segments (segment 1 and segment 2) in a rock discontinuity or hydraulic fracture can be calculated as follows:

$${T}_{s e g} = \frac{{T}_{1} {T}_{2}}{{T}_{1} + {T}_{2}} , \qquad ( 3 )$$

$${T}_{1} = \frac{{k}_{f} {A}_{c}}{{d}_{s e g 1}} , \qquad {T}_{2} = \frac{{k}_{f} {A}_{c}}{{d}_{s e g 2}} ,$$

where k_{f} is the rock discontinuity or hydraulic fracture permeability, A_{c} is the area between the rock discontinuity or hydraulic fracture segments, and d_{seg 1} and d_{seg 2} are the average distances from the two rock discontinuity or hydraulic fracture segments to the common face, respectively.

### IV Intersection Between Two Rock Discontinuities, Two Hydraulic Fractures, or a Rock Discontinuity and a Hydraulic Fracture

Rock discontinuity and/or hydraulic fracture intersections entail the intersection between both polygons in order to calculate a transmissibility factor that models mass transfer appropriately (FIG. 7):

$${T}_{int} = \frac{{T}_{1} {T}_{2}}{{T}_{1} + {T}_{2}} , \qquad ( 4 )$$

$${T}_{1} = \frac{{k}_{f 1} {w}_{f 1} {L}_{int}}{{d}_{f 1}} , \qquad {T}_{2} = \frac{{k}_{f 2} {w}_{f 2} {L}_{int}}{{d}_{f 2}} ,$$

where k_{f1} and k_{f2} are rock discontinuity or hydraulic fracture permeabilities for segments 1 and 2, w_{f1} and w_{f2} are widths of rock discontinuity or hydraulic fracture segments 1 and 2, Lᵢₙₜ is intersection line length. d_{f1} and d_{f2} are average normal distances from the rock discontinuity or hydraulic fracture segments to the intersection line and can be calculated as

$$\begin{matrix}{d}_{f 1} = \frac{{\int }_{{S}_{1}} {x}_{n} d {S}_{1} + {\int }_{{S}_{2}} {x}_{n} d {S}_{2}}{{S}_{1} + {S}_{2}} , & {d}_{f 2} = \frac{{\int }_{{S}_{3}} {x}_{n} d {S}_{3} + {\int }_{{S}_{4}} {x}_{n} d {S}_{4}}{{S}_{3} + {S}_{4}}\end{matrix} , \qquad ( 5 )$$

where dSᵢ represents the area of the element, Sᵢ represents the area of the rock discontinuity or hydraulic fracture sub-segment, and xₙ represents the distance from the centroid of the element to the intersection line.

### V Non-Planar Rock Discontinuity and Hydraulic Fracture Geometries

Non-planar rock discontinuities and hydraulic fractures can be modeled as continuous and consecutive polygons. FIG. 8 shows a representation of a non-planar hydraulic fracture (left side of the figure). Curves are modeled as consecutive polygons (HFS-1, HFS-2, HFS-3, where HFS stands for hydraulic fracture segment and the next number is the index). Where an intersection occurs between two consecutive polygons, an infinitesimal portion of the previous hydraulic fracture segment (F1) crosses the next hydraulic fracture segment (F4), generating smaller segments (F2 and F3). Non-planarity can be introduced by varying the orientation of each polygon, while preserving their connections. Mass transfer is accounted for by treating consecutive polygons' common side as an intersection between two polygons. When two rock discontinuities or hydraulic fracture segments intersect, they generate two large and small sub-segments. Here, the transmissibility is determined by the sub-segments with larger areas (F1 and F4) as larger areas impact more the transmissibility calculation. The equations to calculate transmissibility are similar to the equations used to calculate intersections between two polygons except the calculation of the distances to the intersection line, which take into account the contribution of larger areas only. The equations are summarized below:

$$\begin{matrix}{T}_{int} = \frac{{T}_{1} {T}_{2}}{{T}_{1} + {T}_{2}} \\ \begin{matrix}{T}_{1} = \frac{{k}_{f 1} {w}_{f 1} {L}_{int}}{{d}_{f 1}} , & {T}_{2} = \frac{{k}_{f 2} {w}_{f 2} {L}_{int}}{{d}_{f 2}} ,\end{matrix} \\ \begin{matrix}{d}_{f 1} = \frac{{\int }_{{S}_{1}} {x}_{n} d {S}_{1}}{{S}_{1}} , & {d}_{f 2} = \frac{{\int }_{{S}_{4}} {x}_{n} d {S}_{4}}{{S}_{4}}\end{matrix}\end{matrix} \qquad ( 6 )$$

### VI Hydraulic Fracturing Modeling with 3D DFN Workflow

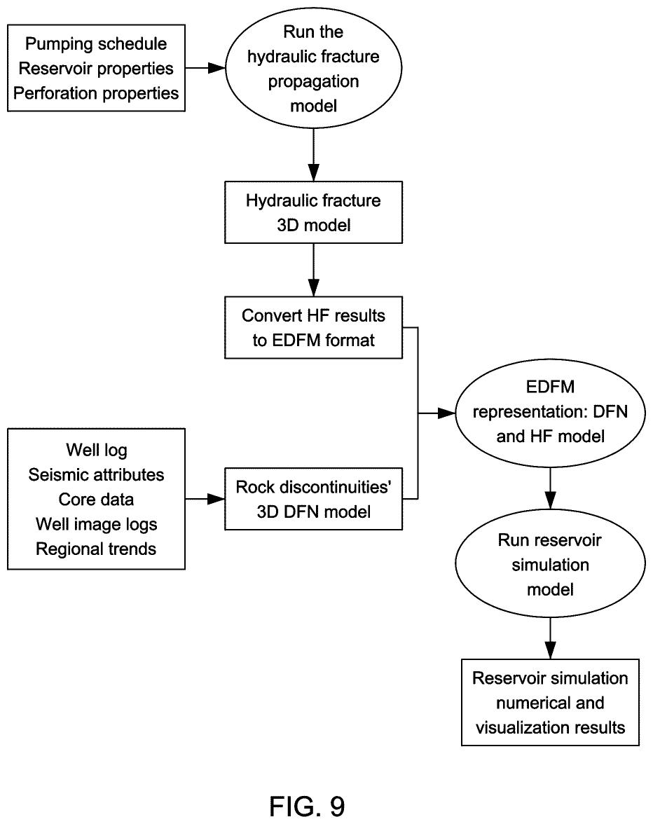

Some workflow embodiments of this disclosure encompasses hydraulic fracture modeling in an ultra-low permeability reservoir with rock discontinuities. Such workflows can use static data such as well image logs, well logs, geological model, seismic interpretations, and core data; and dynamic data such as pumping schedules, well production history, and fracture diagnostics data (if available). FIG. 9 shows a flow chart of a workflow according to an embodiment. The workflow entails:
a) Input dynamic data (e.g., pumping schedule, perforation properties, reservoir model data, etc.) to obtain hydraulic fracture geometry/propagation digital data representing a 3D model of a subterranean region of interest using a conventional hydraulic fracturing propagation simulator software module.
b) Execute a hydraulic fracturing pre-processor to convert the hydraulic fracture geometry data from the conventional simulator module to hydraulic fracture geometry data in EDFM format.
c) Input static data (e.g., well log, seismic attributes, core data, well image logs, regional trends, etc.) to obtain DFN digital data representing a 3D model of the subterranean region using a conventional DFN simulator software module. The model may integrate a natural fracture, bedding layer, and/or faults model in any extension or number.
d) Execute a pre-processor to convert the DFN digital data from the conventional DFN simulator module to data in EDFM format.
e) Produce a separate EDFM computational domain.
f) Input the converted hydraulic fracture geometry data and converted DFN digital data in EDFM format into the computational domain to generate an EDFM representation of the DFN model and the hydraulic fracture model.
g) Perform EDFM processing (e.g., as disclosed in U.S. Pat. No. 10,914,140) and produce output data.
h) Input the produced output data from the EDFM processor into a conventional digital reservoir simulator module. The reservoir simulator module properties may include reservoir and geological data such as reservoir pressure, relative permeability curves, water saturation, permeability, rock compaction tables, and porosity, with rock discontinuity and hydraulic fracture properties including conductivity, geometry, rock compaction tables, and density.
i) Run the digital reservoir simulator module to generate a simulation of the subterranean region.
j) Obtain numerical results and three-dimensional visualizations of the results.

### VII Field Application

A field application of an embodiment of this disclosure was applied to a hydraulic fracturing operation in a shale gas reservoir in Asia. This particular reservoir is characterized as having complex rock discontinuities. The reservoir has ultra-low permeability and low porosity, for which hydraulic fracturing is necessary to access hydrocarbons trapped in the reservoir rock. One horizontal well was present in the reservoir, which was completed with twenty six stages.

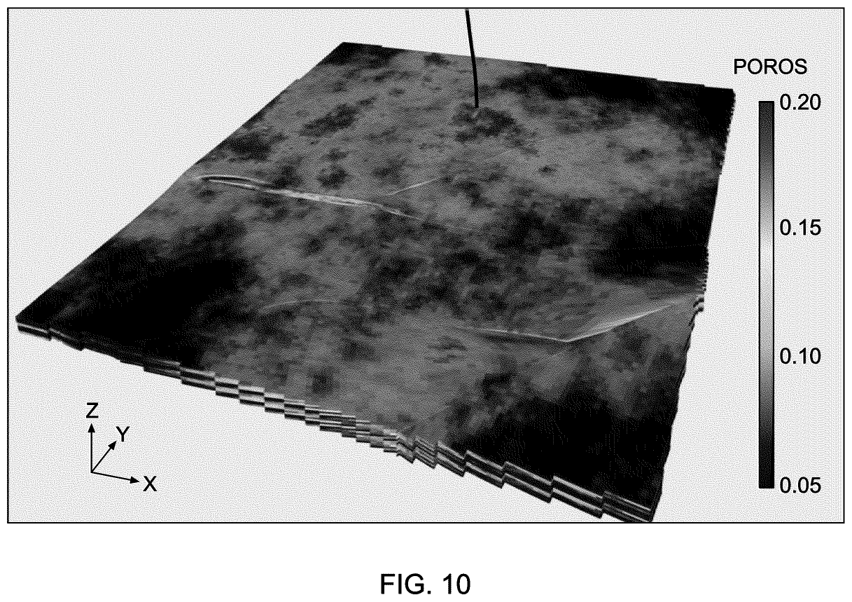

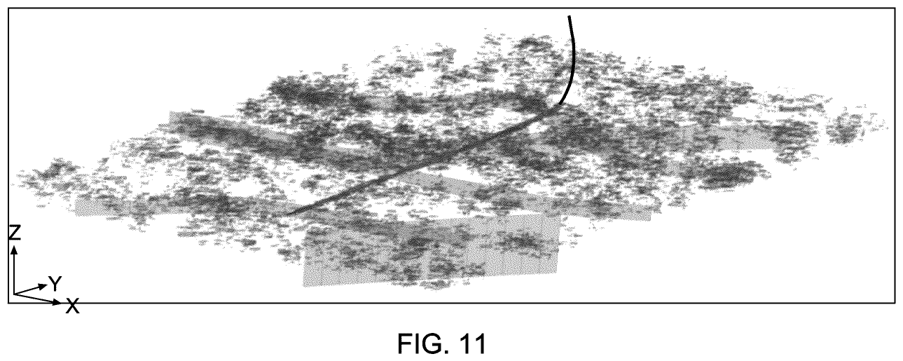

A three-dimensional geological model was built first by using well logs, image logs, seismic interpretations, nearby history matched wells, and geomechanical data to populate reservoir properties such as porosity, pressure, permeability, water saturation, and stress field. FIG. 10 depicts the three-dimensional geological model, showing heterogeneous porosity values in the model. A detailed table containing the reservoir properties used in this field application is presented in Table 1. Regional trend analysis coupled with seismic inversion results were conducted to generate a natural fracture model. Natural fracture orientation was obtained from well image logs and natural fracture dimensions were obtained from nearby history matched wells. Geophysical seismic attributes extracted from Gaussian curvature attribute, maximum likelihood attribute, or ant tracking provide evidence of spatial extension of faults. The present model relied on maximum likelihood attribute to extract large-scale geological discontinuities in the reservoir due to its higher quality and resolution in this location. A bedding layer model was included by analyzing bedding layer distribution and density from well image log interpretations. After identifying rock discontinuities using geological and geophysical domain experience, a discrete fracture network (DFN) model was built to represent them, which has 30850 rock discontinuities (FIG. 11).

TABLE 1

| Reservoir Description | Value | Unit |
|---|---|---|
| Model dimension (x × y × z) | 3700 × 4090 × 108 | m |
| Number of grid blocks (x × y × z) | 132 × 148 × 12 | — |
| Grid blocks dimensions (x × y) | 28 × 27.6 | m |
| Well depth | 2950~3080 | m |
| Well length | 2240 | m |
| Initial reservoir pressure | 50 | MPa |
| Reservoir temperature | 150 | ° C. |
| Matrix water saturation | 0.1 | — |
| Water compressibility | 5.4 × 10⁻⁴ | MPa⁻¹ |
| Reference pressure for compressibility | 0.101 | MPa |
| Natural fractures | 30600 | — |
| Bedding layer | 245 | — |
| Faults | 5 | — |

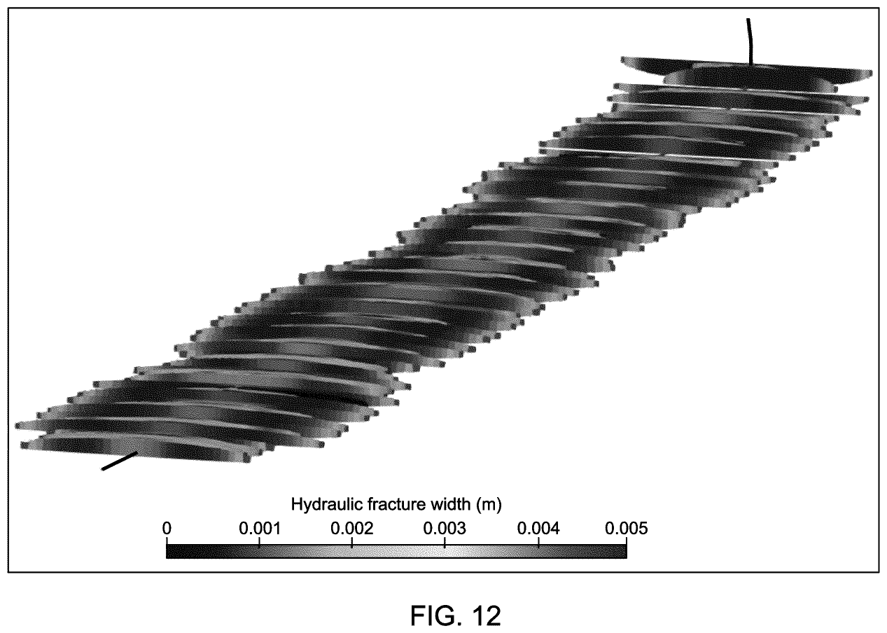

A hydraulic fracture model was set up using a third-party hydraulic fracture propagation model. The model required the description of geomechanical data, perforation data, and pumping schedule for each stage in the hydraulic fracturing job. Table 2 highlights the main data used in this study to generate a hydraulic fracture model. FIG. 12 shows the hydraulic fracture system after obtaining the final results from the fracture propagation model; the hydraulic fracture geometries are then transferred to EDFM by using a hydraulic fracture pre-processor. Hydraulic fracture properties such as conductivity and fracture geometry are also exported. Then, the converted EDFM fracture geometries are embedded into the reservoir model along with the DFN model.

TABLE 2

| Parameter | Value | Unit |
|---|---|---|
| Young's modulus | 39.81 | GPa |
| Poison's ratio | 0.24 | — |
| Layer toughness | 1 | MPa × m^{0.5} |
| Minimum horizontal stress | 77.4 | MPa |
| Maximum horizontal stress | 92.2 | MPa |
| Number of clusters | 180 | — |
| Number of stages | 26 | — |
| Density of slurry | 1010 | Kg/m³ |

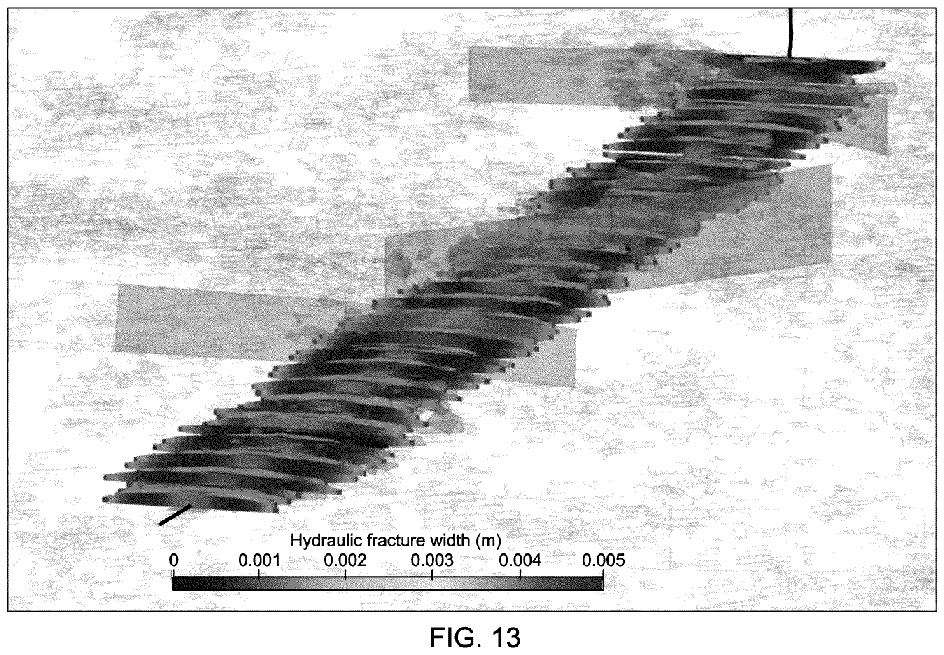

A connectivity analysis was performed to the resulting network, which allowed to discretize groups of connected and disconnected rock discontinuities out of the DFN model. FIG. 13 shows the 3D DFN connected network that was connected to the hydraulic fracture system. The results showed 981 rock discontinuities as part of the hydraulic fracture network. Those discontinuities were given a larger value of conductivity in the modeling process because they were intersected by hydraulic fractures.

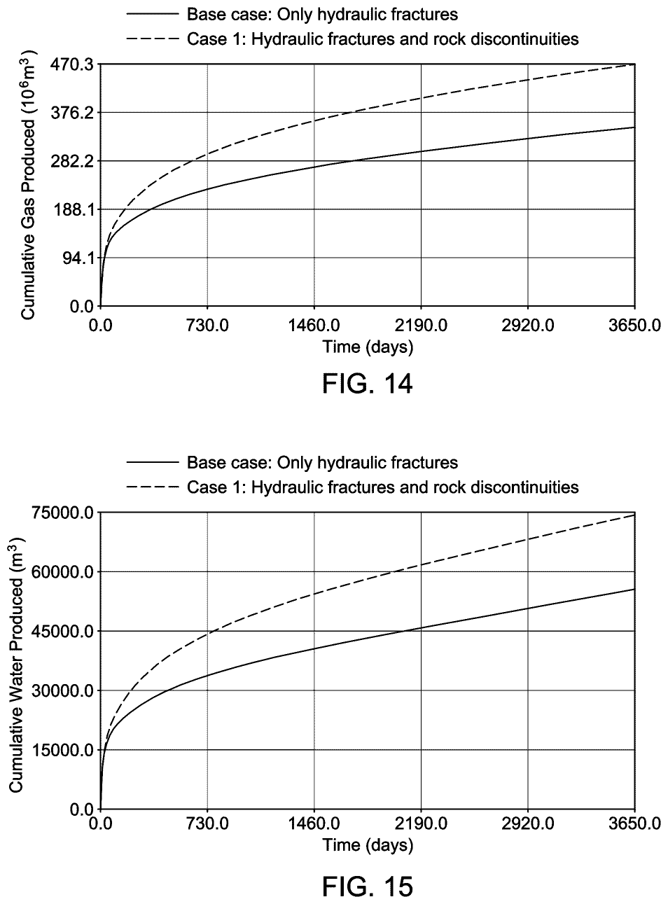

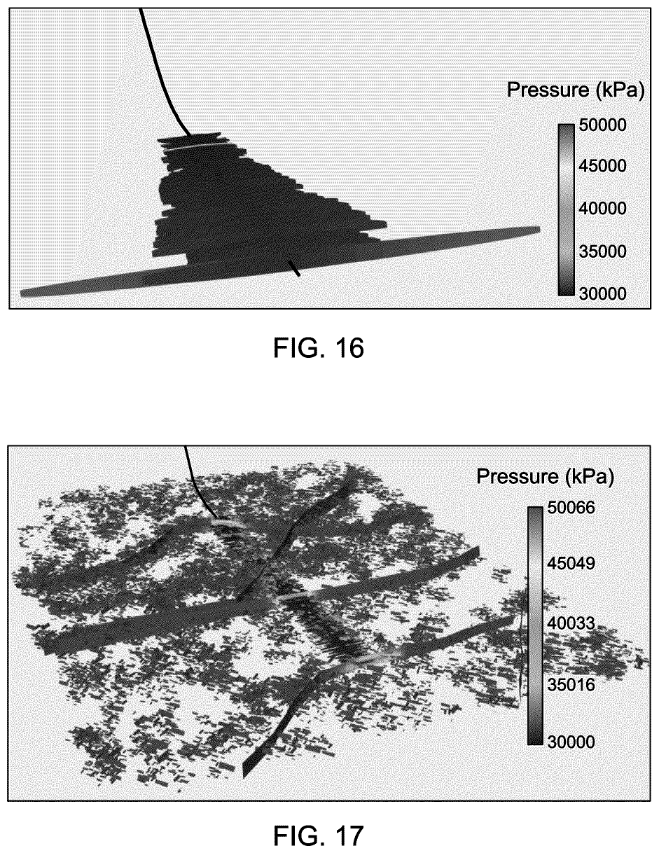

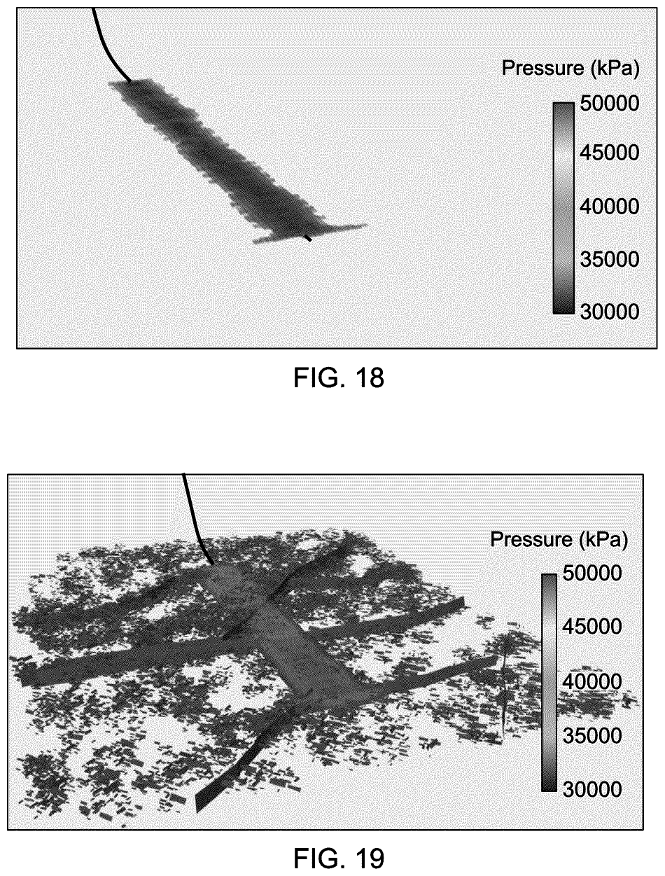

A direct comparison between the base case with only hydraulic fractures and case 1 with hydraulic fractures and rock discontinuities is disclosed. Reservoir simulation results show that the inclusion of a 3D DFN, representing three-dimensional rock discontinuities, impact well performance of a producing shale gas well. Results show 33.5% increase in cumulative gas and water production after 10 years of production, when one considers realistic rock discontinuities in a reservoir simulation workflow. FIG. 14 shows the plot for cumulative gas production. FIG. 15 shows the plot for cumulative water production. The main reason for the increase in production is the inclusion of additional flow paths that were activated in the rock discontinuity network. Additionally, pressure distribution plots in the fracture system for both cases are respectively presented in FIG. 16 and FIG. 17. Drainage reservoir volume plots for both cases are also respectively presented in FIG. 18 and FIG. 19.

Some embodiments of this disclosure utilize data representing the subterranean region produced by conventional reservoir simulators as known in the art. Conventional simulators are designed to generate models of subterranean regions, producing data sets including fracture parameters, well parameters, and other parameters related to the specific production or operation of the particular field or reservoir. Embodiments of this disclosure provide a non-intrusive application of an EDFM formulation that allows for insertion of discrete fractures into a computational domain and the use of a simulator's original functionalities without requiring access to the simulator source code. The embodiments may be easily integrated into existing frameworks for conventional or unconventional reservoirs to perform various analyses as described herein.

Advantages provided by the embodiments of this disclosure include the ability to accurately simulate subsurface characteristics and provide useful data (e.g., fluid flow rates, fluid distribution, fluid saturation, pressure behavior, geothermal activity, well performance, formation distributions, history matching, production forecasting, saturation levels, sensitivity analysis, etc.), particularly for multi-scale complex fracture geometries. Reservoir models with three-dimensional rock discontinuities and hydraulic fractures can be accurately and efficiently simulated by using non-intrusive EDFM. Fluid flow is accurately and efficiently modeled in hydraulic fractures and rock discontinuities by using NNCs, which represent interactions between the reservoir matrix, hydraulic fractures, and any type of rock discontinuity. The embodiments are ideal for use in conjunction with commercial simulators or in-house simulators in a non-intrusive or intrusive manner, overcoming key limitations of low computational efficiency and complex gridding issues experienced with conventional methods.

The EDFM embodiments of this disclosure can handle fractures with any complex boundaries and surfaces with varying roughness. It is common for fractures to have irregular shapes and varying properties (e.g., varying aperture, permeability) along the fracture plane. EDFM embodiments of this disclosure handle different types of structured grids, including Cartesian grids and corner-point grids. The embodiments may be implemented with conventional reservoir simulators or with other applications that generate similar data sets. As a non-intrusive method, the calculations of connection factors, including NNC transmissibility factors and a fracture well index, depend on the gridding, reservoir permeability, thermal conductivity, and fracture geometries.

Embodiments of this disclosure introduce realistic natural fractures, bedding layers, and faults in a reservoir simulation workflow which interacts with subsurface hydraulic fracture processes. The hydraulic fractures and faults from the simulations can be planar or non-planar. Non-planar behavior is produced by heterogeneous stress fields and multi-scale fractures, which is captured by using ensembles of connected polygons. The hydraulic fracture models can be calibrated with production data using the techniques of this disclosure. For this purpose, reservoir features such as reservoir permeability, rock compaction coefficient, water saturation, and relative permeability curves can be tuned manually or automatically (e.g., using artificial intelligence). Hydraulic fracture geometries can also be modified by reducing hydraulic fracture dimensions in order to represent their effective contribution. Rock discontinuity conductivity can also be varied in order to improve the calibration process with production data.

Hydraulic fracture-rock discontinuity interactions can be more accurately represented by using Mohr Coulomb criteria in the techniques of this disclosure. In this approach, activation could be assumed to occur when a propagating hydraulic fracture segment intersects a rock discontinuity, increasing its internal pressure and causing the rock discontinuity to fail in shear. Such activation also depends on the orientation of the rock discontinuity and the amount of pressure inside the propagating hydraulic fracture. Embodiments of this disclosure allow for integration of diagnostics data, which could provide more accurate estimations of hydraulic fracture geometry. Such integration is seamless because variation of hydraulic fracture geometries can be performed using automated hydraulic fracture geometry reduction algorithms. The disclosed embodiments integrate realistic hydraulic fracture modeling, which enhances completion design and understanding of reservoir properties in order to optimize future hydraulic fracturing treatments in subsequent wells in a hydrocarbon field.

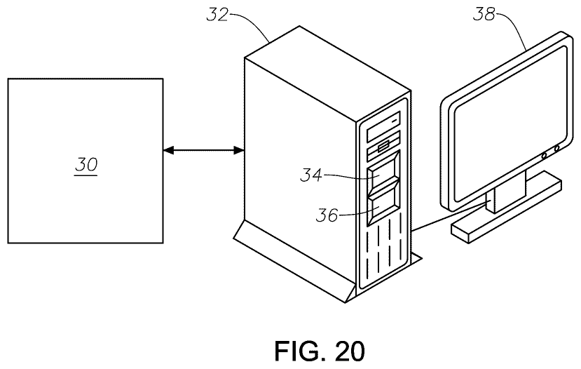

Embodiments of this disclosure may apply one or more preprocessors to provide the disclosed calculations. Taking reservoir and gridding information as inputs, the preprocessor(s) performs the calculations disclosed herein and generates an output of data values corresponding to fracture locations, connectivity parameters, geometry parameters, the number of extra grids, the equivalent properties of these grids, transmissibility factors, and NNC pairings. FIG. 20 shows a system for implementation of embodiments of this disclosure. A simulator module 30 is linked to a computer 32 configured with a microprocessor 34 and non-transitory memory 36 that can be programmed to perform the steps and processes disclosed herein. The output values calculated by the computer 32 are used as data input (commonly referred to as “keywords”) to the simulator module 30 for generation of the desired simulation. In this manner, the disclosed EDFM formulations are applied in a non-intrusive way in conjunction with conventional simulators with NNC functionality. The EDFM keeps the grids of conventional simulators and models rock discontinuities and hydraulic fractures implicitly through different types of connection factors as described herein, without requiring access to or use of the simulator's source code. Alternatively, some embodiments may be implemented as a unitary application (i.e., wherein one module performs both the simulator and preprocessor functions). A display 38 is linked to the computer 32 to provide a visual output of the simulation results. It will be appreciated by those skilled in the art that conventional software and computer systems may be used to implement the embodiments. It will also be appreciated that programming of the computer 32 and microprocessor 34 can be implemented via any suitable computer language (e.g., PYTHON™, FORTRAN™, C, C++, etc.) in accordance with the techniques disclosed herein. In some embodiments, the simulator module 30 may be remotely located (e.g., at a field site) and linked to the computer 32 via a communication network.

In light of the principles and example embodiments described and illustrated herein, it will be recognized that numerous modifications could be applied to the processes to derive numerous alternative embodiments of the present invention. Items such as applications, modules, components, etc., may be implemented as software constructs stored in a machine accessible storage medium, and those constructs may take the form of applications, programs, subroutines, instructions, methods, or any other suitable form of control logic; such items may also be implemented as firmware or hardware, or as any combination of software, firmware and hardware, or any combination of any two of software, firmware and hardware. It will also be appreciated by those skilled in the art that embodiments may be implemented using conventional memory in applied computing systems (e.g., local memory, virtual memory, and/or cloud-based memory). The term “processor” may refer to one or more processors. What is claimed as the invention, therefore, are all implementations that come within the scope of the following claims, and all equivalents to such implementations.

What is claimed is:

1. A system for simulating a subterranean region having fracture geometries, comprising:
at least one processor configured with non-transitory instructions, which when executed cause the processor to perform functions including to:
a) obtain discrete fracture network digital data representing a 3D model of a subterranean region from a first digital simulator module;
b) obtain hydraulic fracture digital data representing a 3D model of the subterranean region from a second digital simulator module;
c) convert the digital data from steps (a) and (b) to a digital EDFM format;
d) produce a computational domain separate from the first digital simulator module and the second digital simulator module;
e) input the converted digital EDFM format data from step (c) into the computational domain to produce output data;
f) input the output data of step (e) into a third digital simulator module; and
g) generate a simulation of the subterranean region with the third digital simulator module.

2. The system of claim 1 wherein:
the function of step (d) includes to produce a matrix grid in the produced computational domain;
the function of step (e) includes to identify geometric relationships between the converted digital EDFM format data and matrix cells in the matrix grid.

3. The system of claim 2 wherein the function of step (e) includes to create at least one new rock discontinuity or hydraulic fracture cell in the computational domain and identify a geometric relationship between the at least one new created rock discontinuity or hydraulic fracture cell and a cell in the matrix grid.

4. The system of claim 3 wherein the function of step (e) includes to identify a non-neighboring connection between the at least one new created rock discontinuity or hydraulic fracture cell and a cell in the matrix grid.

5. The system of claim 4 wherein the function of step (e) includes to represent EDFM format data characterizing subsurface parameters as polygons to produce the output data.

6. The system of claim 3 wherein the function to identify a geometric relationship between the at least one new created rock discontinuity or hydraulic fracture cell and a cell in the matrix grid comprises identification of a connection between the at least one new created rock discontinuity or hydraulic fracture cell and a matrix grid cell corresponding to one or more subsurface rock discontinuities or hydraulic fractures.

7. The system of claim 3 wherein the function of step (e) includes to calculate a fluid flow transmissibility factor between the at least one new created rock discontinuity or hydraulic fracture cell and a cell in the matrix grid.

8. The system of claim 7 wherein the function of step (g) includes to generate the simulation of the subterranean region using the calculated fluid flow transmissibility factor.

9. The system of claim 2 wherein the function of step (e) includes to create a plurality of new rock discontinuity or hydraulic fracture cells in the computational domain and identify geometric relationships between the new created rock discontinuity or hydraulic fracture cells.

10. The system of claim 9 wherein the function to identify geometric relationships between the new created rock discontinuity or hydraulic fracture cells comprises identification of connections between new created rock discontinuity or hydraulic fracture cells corresponding to one or more subsurface rock discontinuities or hydraulic fractures.

11. The system of claim 9 wherein:
the function of step (e) includes to calculate fluid flow transmissibility factors between the new created rock discontinuity or hydraulic fracture cells;
the function of step (g) includes to generate the simulation of the subterranean region using the calculated fluid flow transmissibility factors.

12. A method for simulating a subterranean region having fracture geometries, comprising:
obtaining discrete fracture network digital data produced by a first digital simulator module, the data representing a 3D model of a subterranean region;
obtaining hydraulic fracture digital data produced by a second digital simulator module, the data representing a 3D model of the subterranean region;
converting the obtained discrete fracture network data and hydraulic fracture data to a digital EDFM format;
producing a computational domain separate from the first digital simulator module and the second digital simulator module;
inputting the converted digital EDFM format data into the computational domain to produce output data;
inputting the output data into a third digital simulator module; and
generating a simulation of the subterranean region with the third digital simulator module.

13. The method of claim 12 wherein:
producing a computational domain comprises producing a matrix grid in the computational domain;
inputting the converted digital EDFM format data into the computational domain comprises identifying geometric relationships between the EDFM format data and matrix cells in the matrix grid.

14. The method of claim 13 wherein inputting the converted digital EDFM format data into the computational domain comprises creating at least one new rock discontinuity or hydraulic fracture cell in the computational domain and identifying a geometric relationship between the at least one new created rock discontinuity or hydraulic fracture cell and a cell in the matrix grid.

15. The method of claim 14 wherein inputting the converted digital EDFM format data into the computational domain comprises identifying a non-neighboring connection between the at least one new created rock discontinuity or hydraulic fracture cell and a cell in the matrix grid.

16. The method of claim 14 wherein identifying a geometric relationship between the at least one new created rock discontinuity or hydraulic fracture cell and a cell in the matrix grid comprises identifying a connection between the at least one new created rock discontinuity or hydraulic fracture cell and a matrix grid cell corresponding to one or more subsurface rock discontinuities or hydraulic fractures.

17. The method of claim 14 wherein inputting the converted digital EDFM format data into the computational domain comprises calculating a fluid flow transmissibility factor between the at least one new created rock discontinuity or hydraulic fracture cell and the cell in the matrix grid; and generating the simulation of the subterranean region comprises generating the simulation using the calculated fluid flow transmissibility factor.

18. The method of claim 13 wherein inputting the converted digital EDFM format data into the computational domain comprises creating a plurality of new rock discontinuity or hydraulic fracture cells in the computational domain and identifying geometric relationships between the new created rock discontinuity or hydraulic fracture cells by identifying connections between new created rock discontinuity or hydraulic fracture cells corresponding to one or more subsurface rock discontinuities or hydraulic fractures.

19. The method of claim 18 wherein:
inputting the converted digital EDFM format data into the computational domain comprises calculating fluid flow transmissibility factors between the new created rock discontinuity or hydraulic fracture cells;
generating the simulation of the subterranean region comprises using the calculated fluid flow transmissibility factors.

20. A non-transitory computer-readable medium, embodying instructions for simulating a subterranean region having fracture geometries which when executed by a computer cause the computer to perform a plurality of functions, including functions to:
obtain discrete fracture network digital data produced by a first digital simulator module, the data representing a 3D model of a subterranean region;
obtain hydraulic fracture digital data produced by a second digital simulator module, the data representing a 3D model of the subterranean region;
convert the obtained discrete fracture network data and hydraulic fracture data to a digital EDFM format;
produce a computational domain separate from the first digital simulator module and the second digital simulator module;
input the converted digital EDFM format data into the computational domain to produce output data;
input the output data into a third digital simulator module; and
generate a simulation of the subterranean region with the third digital simulator module.
